(19) United States
(12) Patent Application Publication
(10) Pub. No.: US 2020/0008400 A1
(43) Pub. Date: Jan. 9, 2020

(54) ACCELERATED DEVELOPMENT IN OVO AND ENHANCED MYOGENESIS

(71) Applicant: SIGNIFY NORTH AMERICA CORPORATION, Somerset, NJ (US)

(72) Inventors: Zdenko GRAJCAR, Orono, MN (US); Aaron STEPHAN, Chanhassen, MN (US)

(73) Assignee: Signify North America Corporation, Somerset, NJ (US)

(21) Appl. No.: 16/489,376

(22) PCT Filed: Feb. 27, 2018
(86) PCT No.: PCT/US2018/019869

§ 371 Date: Aug. 28, 2019

Related U.S. Application Data
(60) Provisional application No. 62/623,308, filed on Jan. 29, 2018.
(60) Provisional application No. 62/464,750, filed on Feb. 28, 2017.

(51) Int. Cl. A01K 41/02; A01K 45/00; A01K 31/18

(52) U.S. Cl. CPC A01K 41/023; A01K 31/18; A01K 45/007

(57) ABSTRACT

Methods of utilizing light during incubation of avian eggs to influence characteristics of avian pre- and post-hatch. Specific amounts of energy are provided to incubated eggs through a light source, having particular wavelengths, to accelerate embryo development and promote myogenesis post hatch. Green, red, or blue wavelengths of light, or combinations thereof, are provided to eggs in a temperature controlled incubator to increase myoblast and satellite cell production in avian eggs. The light can be administered to avian eggs in a manner that entrains an embryo's circadian rhythm in the egg.

### CLAIM OF PRIORITY

This patent application claims the benefit of priority to U.S. Provisional Application Ser. No. 62/464,750, entitled “Methods for Accelerated Development in Ovo and Enhanced Myogenesis in Avian,” filed on Feb. 28, 2017, and U.S. Provisional Application Ser. No. 62/623,308, entitled “Methods for Accelerated Development in Ovo and Enhanced Myogenesis in Avian,” filed on Jan. 29, 2018, the benefit of priority of each of which is claimed hereby, and each of which are incorporated by reference herein in its entirety.

### TECHNICAL FIELD

This document pertains generally, but not by way of limitation, to providing light to incubating avian species eggs.

### BACKGROUND

A series of studies from the 1960's and 1970's found that exposure of chicken embryos to white light accelerates development. The first study showed positive effects of light illumination during the first week of incubation, and even within just a 10-hour period. Subsequent work by the same group observed accelerated development within the first day of incubation on the basis of somite development. Both studies showed that egg temperature was not affected, thus attributing the effects to light rather than temperature.

In contrast to early effects of light seen by the first two studies, a subsequent study observed accelerated hatching only when the illumination persisted through day 17 of incubation. However, further evidence for an early effect of light was seen where increased embryo weight was observed at 4.5 days. Additionally, the wavelengths that showed the greatest effects were 566 nm and 400 nm.

When the effect of photoperiod was investigated, it was found that the longer the light period used, the more accelerated the development became. Years later, a study using green filtered fluorescent lighting made a similar observation that hatch time was accelerated.

More recent studies have revisited the use of green light during incubation. This time, using LED technology rather than incandescent or fluorescent lighting, no effects of green light were observed on hatch time. Rather than accelerating development, it was found that incubation with green LED's resulted in miniscule (0%-2%) gains in weight during the incubation period; however, more sizeable (up to 20%) gains in breast muscle mass during the same time period.

In addition, it was found that the enhanced breast muscle in chickens incubated under green light was due to increased myoblast numbers and myofiber size. Satellite cells were also increased as well as actively-dividing muscle cells in birds arising from incubation under green light. At the molecular level, myogenic genes Pax7 and myogenin were shown to be up-regulated in birds arising from incubation under green light. The observation at the molecular level was confirmed and extended by additional work, including effects on the mRNA levels of MyoD1, Myogenin, Myostatin, and Myf5.

After hatching, chickens that had been incubated under green light grew faster and put on more weight than chickens that had been incubated in the dark. Additional work on adult broilers showed that green light stimuli during embryogenesis enhanced the post-hatch birth weight (BW) of male broilers, increased breast muscle growth, and improved the feed conversion ratio, but it did not cause any noticeable changes in breast chemical composition or overall meat quality characteristics.

Still, despite advances, problems still remain. In particular, woody breast, a condition where hard fibers lace the breast continues to be a problem within the chicken industry. In particular, with advances in rearing chicken, a significant percentage of chicken have breasts that grow larger than the chicken itself can handle resulting in muscle myopathy wherein necrosis of muscle fibers with macrophage infiltration. Thus, fibrosis occurs resulting in the replacement of proteins within the muscle with collagen, creating a very tough muscle mass that is difficult to consume and has the appearance of split wood. The look and toughness are not desired by consumers often causing the chicken to be discarded or used in a non-preferred manner.

### SUMMARY

The present subject matter relates to methods of utilizing light during incubation to influence characteristics of avian pre- and post-hatch. More specifically, this document relates to providing a specific amount of energy to incubated eggs through a light source to accelerate embryo development and promote myogenesis post hatch. Thus, a principle object of the present application is to utilize lighting methods to improve embryotic and post hatch development of avian.

Aspect 1 can include or use subject matter (such as an apparatus, a system, a device, a method, a means for performing acts, or a device readable medium including instructions that, when performed by the device, can cause the device to perform acts), such as can include: administering a green light having a wavelength of 500 to 600 nanometers (nm) to avian eggs during an early embryogenesis, a middle embryogenesis, and a perinatal stage of the avian eggs during incubation; wherein myoblast and satellite cell production is increased in the avian eggs in response to the administration of the green light.

Aspect 2 can include, or can optionally be combined with the subject matter of Aspect 1, to optionally include administering the green light to the avian eggs in a manner which entrains the embryo's circadian rhythm.

Aspect 3 can include, or can optionally be combined with the subject matter of one or any combination of Aspects 1 or 2 to optionally include: establishing a preferred temperature range for the incubation of the avian eggs; and controlling a temperature inside an incubation chamber housing the avian eggs to continuously be within one-degree Fahrenheit of the preferred temperature range.

Aspect 4 can include, or can optionally be combined with the subject matter of Aspect 1 to optionally include: administering the green light to the avian eggs in a manner which entrains the embryo's circadian rhythm; establishing a preferred temperature range for the incubation of the avian eggs; and controlling a temperature inside an incubation chamber housing the avian eggs to continuously be within one-degree Fahrenheit of the preferred temperature range.

Aspect 5 can include, or can optionally be combined with the subject matter of one or any combination of Aspects 1 through 4 to include wherein the wavelength of the green light is between 540 and 560 nm.

Aspect 6 can include, or can optionally be combined with the subject matter of one or any combination of Aspects 1 through 5 to include wherein the increased number of myoblast and satellite cells results in an increased number of muscle fibers and improved muscle regeneration in the breast muscles of the avian species.

Aspect 7 can include, or can optionally be combined with the subject matter of one or any combination of Aspects 1 through 6 to include: administering a red light having a wavelength of 620 to 780 nm to the avian eggs.

Aspect 8 can include or use, or can optionally be combined with the subject matter of Aspect 7, to optionally include wherein the red light is administered only after the avian eggs are in an exothermic phase of an incubation cycle.

Aspect 9 can include, or can optionally be combined with the subject matter of one or any combination of Aspects 7 or 8 to optionally include wherein the red light is administered in a manner which entrains an embryo's circadian rhythm in the avian eggs.

Aspect 10 can include, or can optionally be combined with the subject matter of one or any combination of Aspects 1 through 9 to include: exposing the avian eggs to a substantially blue wavelength of light during a period of time during a first seven days of incubation of the avian eggs.

Aspect 11 can include or use, or can optionally be combined with the subject matter of Aspect 10, to optionally include wherein the period of time is 24-hours per day.

Aspect 12 can include, or can optionally be combined with the subject matter of one or any combination of Aspects 1 through 11 to include controlling on and off times of light and an intensity of the lights with a control system electrically connected to the light.

Aspect 13 can include, or can optionally be combined with the subject matter of one or any combination of Aspects 1 through 5 to include wherein the green light is generated by a plurality of light emitting diodes.

Aspect 14 can include, or can optionally be combined with the subject matter of one or any combination of Aspects 7 through 9 to include wherein the red light is generated by a plurality of light emitting diodes.

Aspect 15 can include, or can optionally be combined with the subject matter of one or any combination of Aspects 1 through 14 to include wherein the avian species is chicken.

Aspect 16 can include, or can optionally be combined with the subject matter of one or any combination of Aspects 1 through 14 to include wherein the avian species is turkey.

Aspect 17 can include, or can optionally be combined with the subject matter of one or any combination of Aspects 1 through 14 to include wherein the avian species is duck.

Aspect 18 can include or use subject matter (such as an apparatus, a system, a device, a method, a means for performing acts, or a device readable medium including instructions that, when performed by the device, can cause the device to perform acts), such as can include: exposing avian eggs to a green light having a wavelength in a range of 500 to 600 nanometers (nm); wherein the average hatch time of the avian eggs is reduced by at least 4% and chicks hatched from the avian eggs do not exhibit sub-optimal development.

Aspect 19 can include, or can optionally be combined with the subject matter of Aspect 18, to optionally include wherein the wavelength of the green light is in a range of 540 to 560 nm.

Aspect 20 can include, or can optionally be combined with the subject matter of one or any combination of Aspects 18 or 19 to optionally include: establishing a preferred temperature range for the incubation of the avian eggs; and controlling a temperature inside the incubation chamber to continuously be in within one-degree Fahrenheit of the preferred temperature range.

Aspect 21 can include, or can optionally be combined with the subject matter of one or any combination of Aspects 18 through 20 to optionally include: wherein the green light is provided in a circadian manner for the entire incubation period.

Aspect 21 can include, or can optionally be combined with the subject matter of one or any combination of Aspects 18 through 21 to optionally include: wherein the avian eggs are chicken eggs.

Aspect 22 can include, or can optionally be combined with the subject matter of one or any combination of Aspects 18 through 21 to optionally include: wherein the avian eggs are turkey eggs.

Aspect 23 can include, or can optionally be combined with the subject matter of one or any combination of Aspects 18 through 21 to optionally include: wherein the avian eggs are duck eggs.

Aspect 24 can include, or can optionally be combined with the subject matter of one or any combination of Aspects 1 through 23 to optionally include: the green light delivers between 0.2 Watts per square meter (W/m²) and 10 W/m² to a surface of the avian eggs.

Aspect 25 can include or use, or can optionally be combined with any portion or combination of any portions of any one or more of aspects 1 through 24 to include or use, subject matter that can include means for performing any one or more of the functions of aspects 1 through 23.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of an incubation chamber.

FIG. 2A is a perspective view of a setter incubation device with a light supporting device secured thereto.

FIG. 2B is a perspective view of a hatcher incubation device with a light supporting device secured thereto.

FIG. 2C is a perspective view of a setter incubation device with a light supporting device secured thereto.

FIG. 3A is a perspective view of a light supporting device.

FIG. 3B is a perspective view of a light supporting device.

FIG. 3C is a perspective view of a light supporting device.

FIG. 4A is a partial perspective view of a light supporting device.

FIG. 4B is a perspective view of a multi-piece light supporting device.

FIG. 5 is a sectional view of a lighting device.

FIG. 6 is a schematic diagram of circuitry for a lighting device.

FIG. 7 is a diagram of a control system for a lighting device.

FIG. 8 is a partial perspective view of a light supporting device for use within an incubation chamber.

FIG. 9 is a spectral output graph for a green LED.

FIG. 10 is the spectral output graph for a red LED.

### DETAILED DESCRIPTION

In the following detailed description, numerous specific details are set forth by way of examples in order to provide a thorough understanding of the relevant teachings. However, it should be apparent to those skilled in the art that the present teachings can be practiced without such details. In other instances, well known methods, procedures, components, and/or circuitry have been described at a relatively high-level, without detail, in order to avoid unnecessarily obscuring aspects of the present teachings.

The various systems and methods disclosed herein relate to controlling or influencing characteristics and genetics of embryos in eggs in order to promote the development of the embryos and enhance characteristics of the avian species during their life.

The systems and methods rely on the application of light, having selected wavelength and intensity, to incubated eggs to provide a predetermined amount of energy to the incubated eggs over time. The systems include an incubating device having an interior cavity in which lighting elements emitting light having the selected wavelength are mounted. The lighting elements can be mounted on trays designed to hold the eggs, such that light emitted by the lighting elements irradiates the eggs. The lighting elements can be mounted on light supporting devices that are permanently or removably mounted to the interior of the incubator or to the setting or incubating devices within the incubator. The lighting elements illuminate the eggs during the incubation period, and thereby promote growth of the embryo and resulting avian.

Green light, light having a wavelength in the range of approximately 495 nanometers (nm) to 600 nm, affects developmental rates, including myogenesis, before the avian species' visual system is even developed embryonically. Energy from the green light is absorbed by a compound present in the egg, resulting in heating or oxidation of the compound, which changes the biological activity of the embryo. It is believed that several biological processes can contribute to these changes, including: when the light absorbing molecule absorbs the photon of the green light, a signal transduction cascade is initiated such that the embryo perceives the light which changes physiological and/or biochemical statuses; nitric oxide signaling is altered by the green light; glucose oxidation is inhibited causing the embryo to use more proteins and lipids; and the green light causes the embryo to develop beyond a glucose-dependent stage. Additionally, green light increases nitric oxide metabolism, which has been shown to upregulate myogenic differentiation factors.

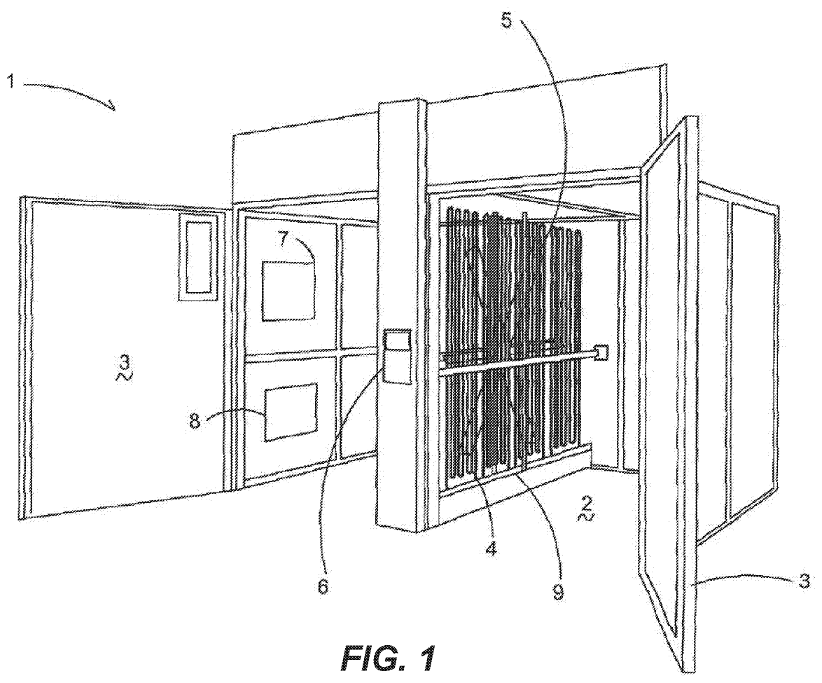

FIG. 1 depicts an incubation chamber 1 generally having an open interior 2, which can be closed and sealed by a door member 3. When closed the door member 3 forms an airtight seal to keep the internal environmental conditions within the interior 2 controlled.

At least one temperature control member 4 is within the incubation chamber that in one embodiment is a radiating coil having fluid conveyed therethrough to provide heat or cool air to keep the interior 2 at a predetermined temperature. In one embodiment a fan element 5 is spaced apart from the temperature control member 4 to convey air through the incubation chamber to ensure even temperature distribution throughout the chamber 1. The fan element 5 extends the height of the chamber 1 to circulate air accordingly. In one embodiment an incubation chamber has two door members that seal to the outside and the fan element 5 is positioned between the door elements to be centrally located within the incubation chamber 1 and again convey air and thus provide temperature control throughout the chamber 1.

A control unit 6 is electrically or digitally through over the air communication connected to the fan element 5 and temperature control member 4 and includes sensor elements 7 and 8 that monitor the environmental conditions within the chamber 1. In one embodiment the sensor elements 7 and 8 are a humidity sensor and temperature sensor respectfully. Typically, the control unit 6 is located on the exterior of the chamber 1 to provide read outs of the environmental conditions with the chamber 1 for a user. The control unit 6 operably actuates the temperature control member 4 and fan element 5 to keep both the humidity and temperature at the proper settings throughout a predetermined incubation period.

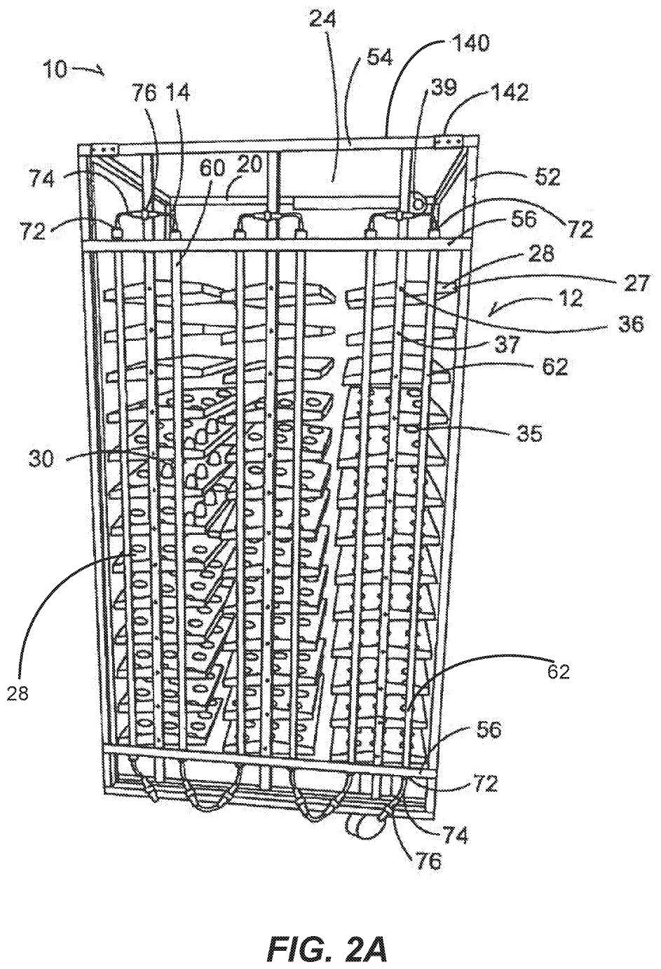

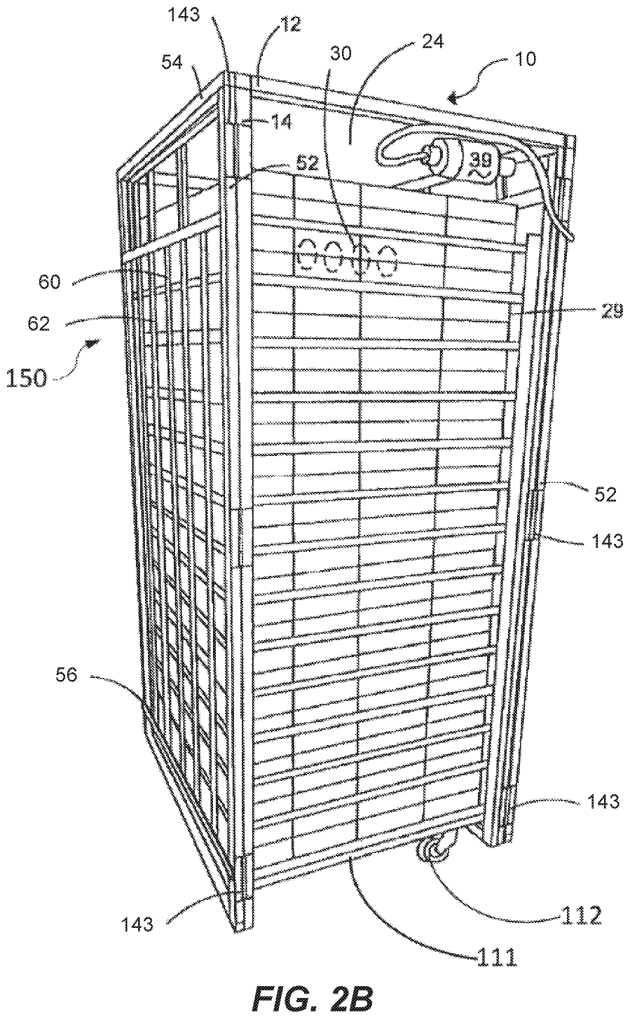

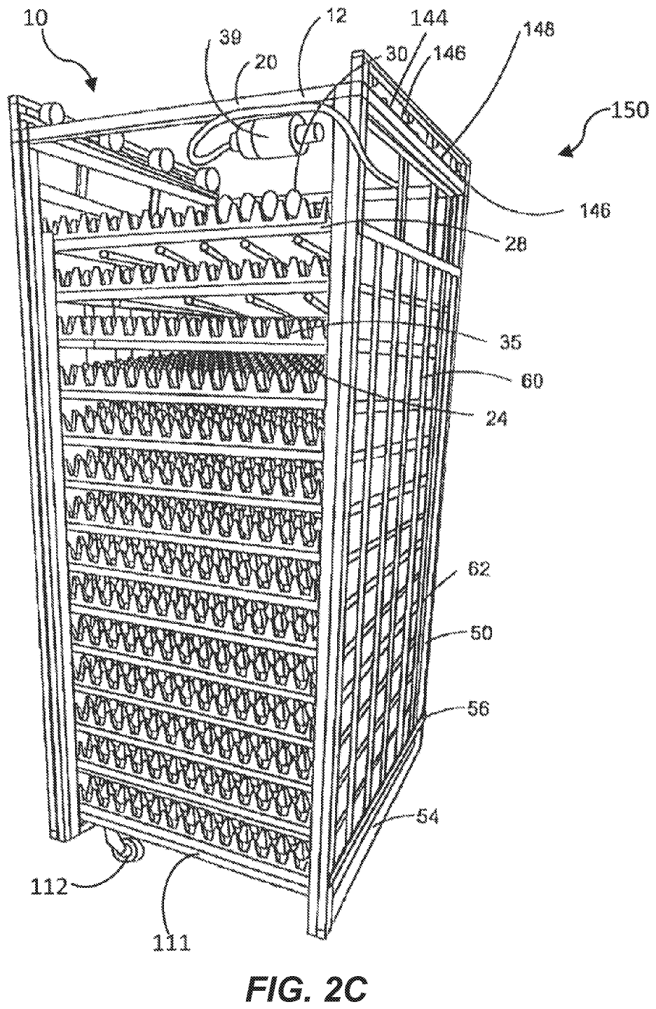

Rail elements 9 are disposed within and extend in the interior 2 of the chamber 1 generally in front of the temperature control member 4 and fan element 5. In an example, the rail elements 9 are presented to protect the temperature control member 4 and fan element 5, and are spaced apart therefrom such that when incubating devices 10 (not shown in FIG. 1) are put into the incubation chamber 1, typically rolled in, the incubation devices 10 engage the rail element 9 instead of the temperature control member 4 or fan element 5. The rail elements 9 also assist in guiding and centering the incubation devices 10 (shown in FIG. 2A) into the interior 2 so that a maximum number of incubation devices 10 can be placed within the interior 2 of the incubator 1.

The incubating device 10 is of any type (depicted in FIGS. 2A-2C), including but not limited to setters or setting devices (depicted in FIG. 2A, and FIG. 2C), hatchers or hatching devices (FIG. 2B) and the like. In the illustrative embodiments depicted, the incubating devices 10 have a body 12 that is a frame that has a generally rectangular cuboid shape having vertical support members 14 parallel to each other. The vertical support members are connected to and orthogonal to horizontal support members 20 that are themselves in parallel to each other. While the body or frame 12 is open, the frame has a hollow interior cavity 24.

A plurality of tray holding members 27 are disposed within the interior cavity 24 to hold egg trays 28. These trays 28 hold a plurality of eggs 30 within a plurality of stabilizing members 35 such as but not limited to slots, holes, openings, cups or the like that are configured to hold an prevent movement of an egg 30. In one embodiment the egg tray 28 and/or the egg basket 29 (FIG. 2B) is made of a transparent material to allow light to pass through to permit complete irradiation of the eggs 30. In example embodiments, both a tray 28 and basket element 29 are utilized with the basket element 29 underneath the tray 28 to receive hatched chicks. In another example, the basket elements 29 (FIG. 2B) themselves both hold the eggs 30 and provide an area for the hatched chicks. The egg trays 28 in one embodiment are slidable within the body 12 such that each egg tray slides onto holding member 27 and can be pulled off of egg tray holding member 27 so that the eggs 30 can be retrieved. The eggs 30 can be of any avian species, including, but not limited to chicken eggs, turkey eggs, duck eggs, goose eggs, quail eggs, and the like. Reptilian and other species' eggs can also be used.

In some embodiments a tilting system 36 is provided to cause the holding members 27 and egg rays 28 to rotate or tilt to various angles in response to simulate the movement the egg 30 would encounter in nature, for example, as the egg is laid upon by a hen or subject to other environmental conditions. In one example, each tray holding member 27 is mounted on a rotatable axle 37 mounted to and controlled by a rotational actuator 39. The actuator 39 is itself mounted to the body 12, and is operative to move the tray holding members 27 with respect to the body 12 as is known in the art. The actuator can continuously or periodically move the holding members 27 having the eggs 30 disposed thereon. In the one example, the actuator 39 is operative to rotate the tray holding member 27 between a horizontal position (as shown) and angled positions in the clockwise and counter-clockwise directions. The angled positions can correspond to angles measured from the horizontal and can range between 0 and a maximum angle (e.g., 15° or 30°). The maximum angle is generally selected such that even when the holding member 27 is rotated to the maximum angle, any eggs 30 disposed on or in holding member 27 are not dislodged from the stabilizing member 35.

FIG. 2B depicts an example of a hatching device. When the avian eggs are ready to hatch, generally three days before the average hatch time, the eggs 30 are removed from the setting device of FIGS. 2A and 2C and moved into hatching trays 29. Hatching device 10 is generally on a platform 111 with wheels 112 to permit easy movement of the hatching device. Device 10 can include support members such as 52 and 12 that are joined to make a cage for egg baskets 29, Other times, egg baskets 29, which contain eggs 20, are stacked one on top of the other with no support members.

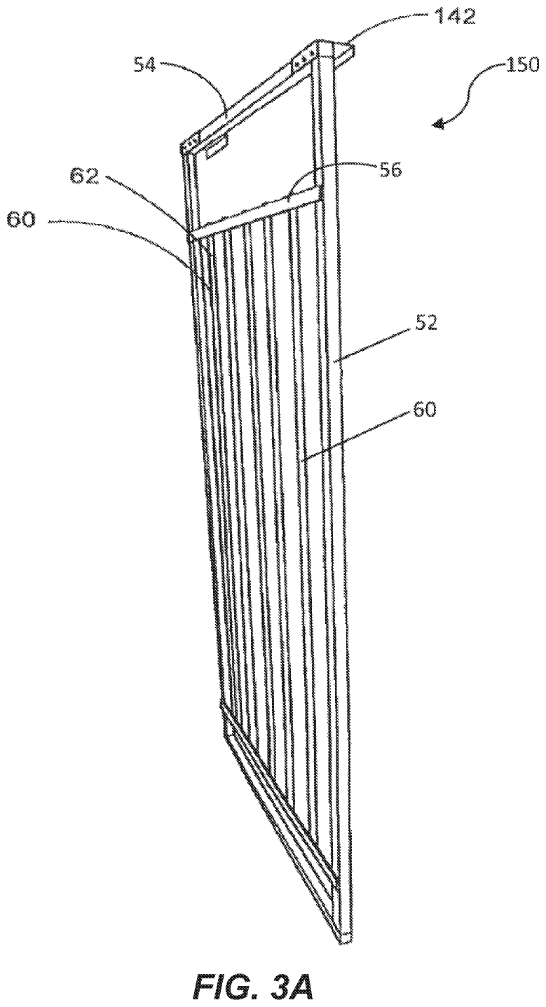

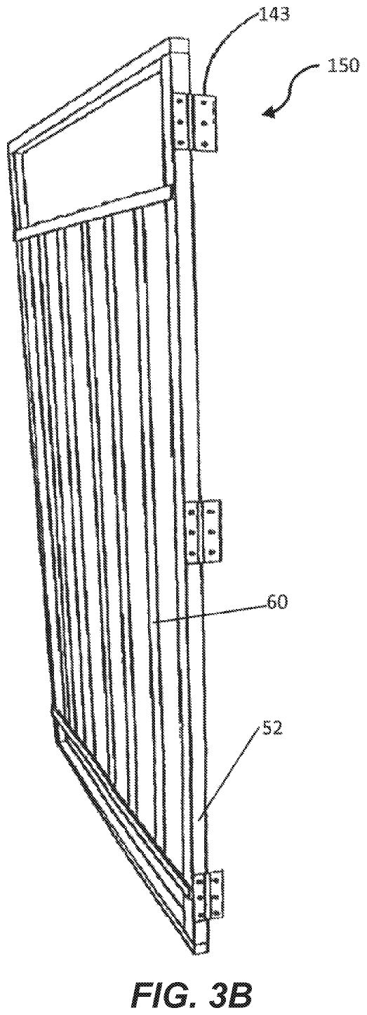

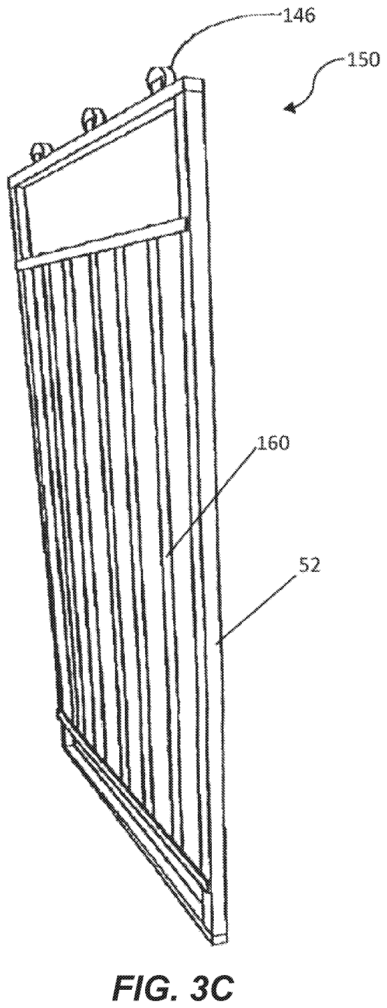

FIGS. 3A-3C depict a variety of light supporting devices 150 having vertical support members 52 aligning with the vertical support members 14 of the hatcher/setter body 12 and horizontal support members 54 aligning with the horizontal support members 20 of the hatcher/setter body 12. The light supporting device 150 has auxiliary horizontal support members 56 extending between the vertical hatcher/setter support members 14. The auxiliary horizontal support members 56 align with an edge of a hatcher/setter holding member 27. In an example, the support members of the light supporting device 150 are of one-piece construction. While described and shown in the figures as a solid frame with support members, light supporting device is any device, including a hung wire or the like that supports a plurality of lighting devices 60 in a manner that allows light from the lighting devices 60 to irradiate the eggs 30 within the setter/hatcher cavity 24.

In the embodiment of FIGS. 3A-3C a plurality of lighting devices 60 are secured to the light supporting device 150 and attached to the auxiliary horizontal support members 56. The lighting devices 60 are spaced apart evenly across the light supporting device 150, in one embodiment in a grid like manner, such that a generally evenly spread out intensity of light is provided on the eggs 30. In particular the lighting devices are spaced such that when the support device is secured in place the lighting devices are laterally spaced from the vertical support members 14 of the setter/hatcher body 12. This provides for maximum coverage of eggs 30 within the setter/hatcher holding members 27. In addition, the light supporting device 150 in general is in a single plane and is of size and shape to fit within the space formed between the rail element 9 and either the temperature control member 4 or fan element 5 to minimize the space taken up by the light supporting device 150 within the interior and allow the light supporting device 150 to fit within the incubating device 1.

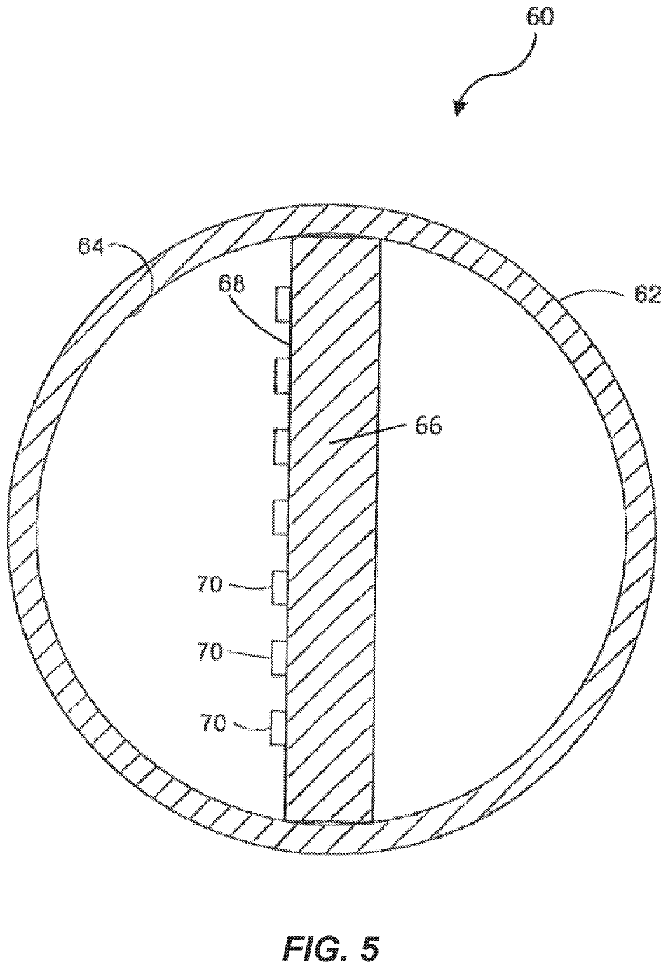

The lighting devices 60 can be of any type, including but not limited to incandescent lights, compact fluorescent lights, high pressure solid lights, LED lights or the like. Similarly, the lighting devices can be strip lights on a single plane, individual LEDs, tube lights or the like. In an example embodiment as depicted in FIG. 5 the lighting devices 60 are tube lights having an elongated tubular body 62. The elongated tubular body 62 in one embodiment utilizes reflective material on half of its surface to reflect light in a single direction. The elongated tubular body 62 also has a hollow interior 64 that receives a substrate 66 that in one embodiment is a printed circuit board having driving components or circuitry 68 thereon to operate lighting elements 70 that in an example are a plurality of light emitting diodes (LEDs) secured to the substrate 66. The substrate 66 engages the interior of the elongated tubular body 62 such that heat from the driving components 68 and lighting elements 70 is conveyed from the substrate 66 to the elongated tubular body. Any additional heat sink engaging the substrate can be utilized without falling outside the scope of this invention.

The lighting elements 70 are directional and when used in combination with the reflective material of the elongated tubular body 62 to increase light within the interior cavity 64, the maximum amount of light is directed toward the interior cavity 24 of the device 10. As a result of the directional nature of the lighting elements 70 the light supporting device 150 is designed so that when positioned in its place to emit light on the eggs 30 the lighting elements are angled to direct light that is away from or does not emit light on the vertical support members 14 of the body to provide an even spread of light on the eggs 30 without losing light due to reflection or blocking by the body 12. Further, the lighting elements 70 of the lighting devices 60 are positioned direct light at an angle that accounts for the rotation of the tray holding members 27 and egg trays 28 to ensure the amount of light on the surface area increases as rotation occurs in a first direction. In addition, more than one light supporting device 150 can be utilized and attached to a different side of the incubation or setter device 10 to increase the light within the cavity 24. Thus, as a result of the directional nature of the lighting elements 70, the positioning of the light supporting device 150 or use of multiple light supporting devices 60, all exposed surfaces, or at least a majority of the surfaces, of the plurality of eggs are irradiated. Thus, efficiencies are increased.

Shown in FIG. 2A, end caps 72 are secured to the ends of the elongated tubular body 62 and are of type to seal the hollow interior 64 while providing access to wiring 74 to provide electrical power to the lighting 60 and to permit the lighting devices 60 to be electrically connected via a plurality of electrical connectors 76. The end caps 72 in one embodiment provide a water proof seal such that when wash down of the body occurs the ingress of water within the lighting device 60 is prevented and water does not penetrate within the tubular body 62.

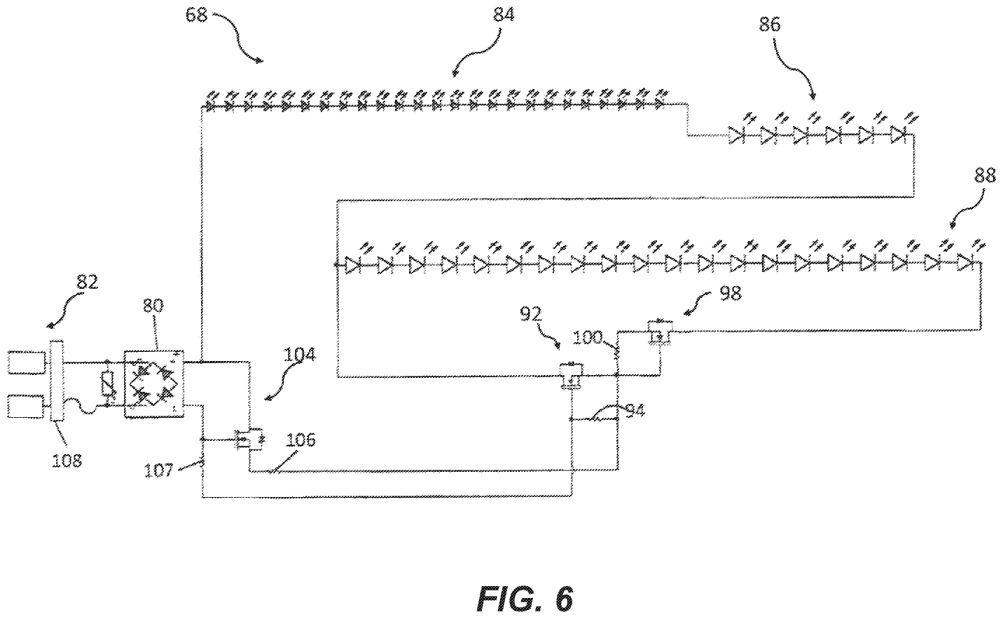

FIG. 6 depicts an example driving circuitry 68. The driving circuitry 68 is similar to that taught in U.S. Pat. No. 8,373,363, entitled “Reduction of Harmonic Distortion for LED Loads,” to Z. Grajcar, issued on Feb. 12, 2013, and U.S. patent application Ser. No. 12/824,215, entitled “Color Temperature Shift Control for Dimmable AC LED Lighting,” to Z. Grajcar, filed on Jun. 27, 2010, the entire contents of each of which are incorporated herein by reference.

The circuitry 68 includes a rectifying device 80 that receives current from an AC source 82 and includes a first group of light emitting diodes 84 arranged in series with a second group of light emitting diodes 86. Circuit 68 is just one example of a driving circuit that can be utilized with lights 60 of the present disclosure. In an example, the first group of light emitting diodes 84 comprise LEDs that emit green light with a wavelength between 550 nm-570 nm. Note that a light source can be operative to produce light having a spectrum substantially concentrated within the specified range or narrow band of wavelength (e.g., 550 nm-570 nm, or other narrow wavelength range) when over 90% or over 95% of the lighting energy emitted by the light source is within the specified narrow range of wavelengths. In some examples, the light source can thus also emit a small amount of light outside of the specified range. For LED's the specified band of wavelength, specific wavelength, or narrow band of wavelength can refer to the wavelength at which the LED emits maximum spectral power. Other lights and spectral outputs will work with the present subject matter as long as there is sufficient light to obtain the desired purpose and no or minimal light that will have a deleterious effect. This narrow band of wavelengths includes wavelengths that are visible to humans and ultraviolet and infrared wavelengths not visible to humans, including but not limited narrow bands of wavelength in any range from 300 nm to 800 nm. In an example, light having a wavelength between 495 nm and 570 nm is emitted. In another example, light having a wavelength between 540 nm and 560 nm is emitted.

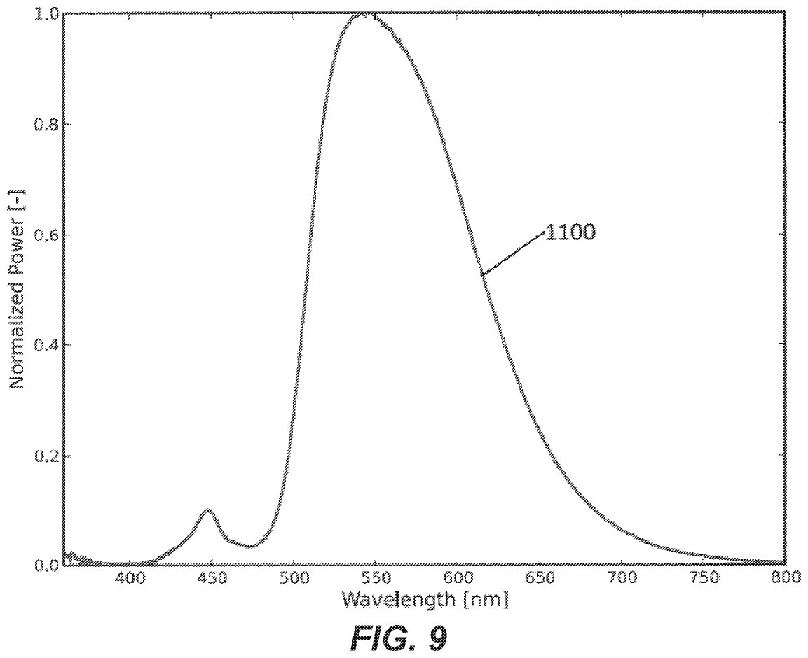

FIG. 9 shows the spectral curve for an exemplary green LED. Curve 1100 is shown with a peak spectral content at approximately 450 nm. This LED is a Lime LED Luxeon Sunplus35 L1SP-LME0003500000 by Lumileds.

The embodiments disclosed herein can also contain a second group of light emitting diodes 88 (FIG. 6) comprise LEDs that emit a single narrow band wavelength. This narrow band of wavelengths includes wavelengths that are visible to humans, and ultraviolet and infrared wavelengths not visible to humans, including but not limited narrow bands of wavelength in any range from 300 nm to 800 nm. In an example, the second group of light emitting diodes 88 emit white light. In an example, light substantially concentrated between 430 nm and 470 nm is emitted. Alternatively, the second group of LEDs 88 emit light having a wavelength between 620 nm-660 nm. Alternatively, the second group of LEDs 88 comprises a mix of LEDs with some emitting light having a wavelength between 430 nm and 470 nm and other emitting light having a wavelength between 620 nm-660 nm.

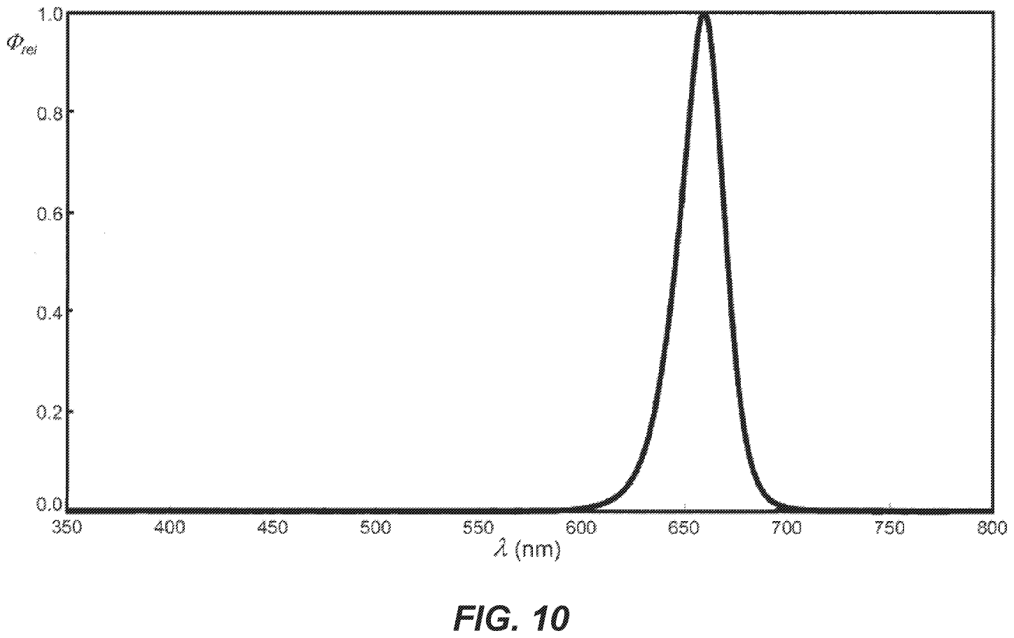

In another example, the second group of LEDs 88 emit light at a wavelength that increases the shell penetration of the light into the egg over other wavelengths based on the type and color of egg being incubated. Specifically, certain wavelengths of light, such as 620 nm-660 nm light has been shown to emit or penetrate through certain egg shells, including but not limited to brown turkey egg shells at a greater rate than other wavelengths of light, providing light energy directly to the embryo at a greater rate than other wavelengths. Alternatively, the first group of LEDs emit white light or a combination of narrow bands of wavelengths and white light. In one embodiment, a red LED is used. FIG. 10 depicts the spectral output for an exemplary red LED with a peak spectral content at 660 nm. This LED is a Hyper Red Osram LH CPDP-3T47-1-0-350-R18 from Osram.

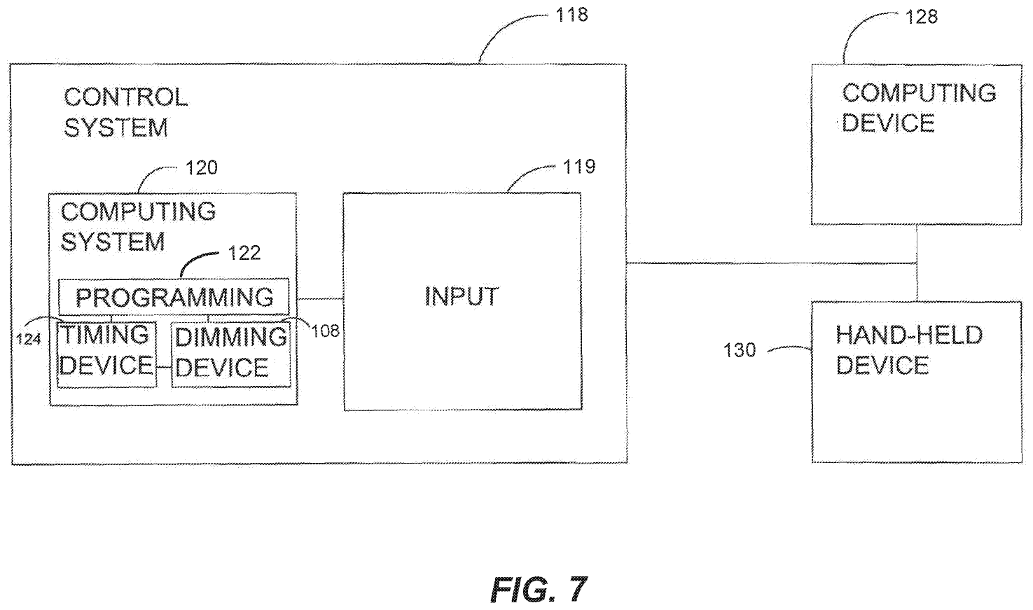

A control system 118 is depicted in FIG. 7 and is electronically connected to the lighting devices 60, and in one embodiment is the control unit 6 of the incubation chamber 1. The control system 118 includes an input 119 for actuating a computing system 120 having programing 122 therein associated with a timing device 124. The control system 118 additionally controls the dimming device 108 that is electrically connected to the timing device 124 such that the programing 122 at predetermined periods automatically dims the lighting assemblies 150 to a predetermined light setting. In this manner the control system 118 actuates the lighting devices 60 to provide pre-determined periods of light and dark during a 24-hour cycle.

The control system 118 in an example can communicate remotely through over the air communications, such as via Wi-Fi or other wireless data protocols, as is known in the art, to provide lighting and dimming information to an individual having a remote computing device 128 or handheld device 130 having the capability to receive such communication. In an example, the computing device 128 or handheld device 130 can be used to communicate instructions to the control system 118 such that the control system 118 is remotely controlled by the remote device 128 or 130. Examples of the remote devices can include, but are not limited to, computers, laptop computers, tablet computers (e.g., iPads), smartphones, remote controls, and the like.

Thus, in operation the control system 118 is programed to provide not only predetermined wavelengths or colors, in addition the timing device 124 sets predetermined intervals for each day. In one example, the control system 118 can provide 16 hours of light during a day and then turn the LED groups 84 and 86 off for 8 hours. Then after the 8 hours, the dimming device 108 is actuated to again provide light. The programing 122 can additionally be configured to then vary the predetermined periods of time, including first and second incubation periods of time and daily periods of time. Thus, during the incubation period of time each daily period of time can have different settings of dark and light.

The predetermined wavelengths, predetermined incubation periods and predetermined day periods are determined by multiple factors. These factors can include, but are not limited to, relative intensity of the light, egg type, including whether the egg type is species (turkey, chicken, duck, and the like), sex (broiler, layer and the like) or breed (Cobb, Ross and the like) related, hatch time, increased shell penetration and the like.

In an example embodiment as depicted in FIG. 2A, an attachment system 140 is also provided to removably secure the light supporting device 150 to the body 12. In an example, the attachment system 140 has brackets 142 that receive the upper horizontal support member 20 of the body to hang the light supporting device 150 on the body and stabilize the light supporting device 150 to prevent vertical movement of the light supporting device 150. In an example, each bracket 142 is C-shaped to provide additional stability to the light supporting device 150.

In another example embodiment as depicted in FIGS. 2B and 3B the light support device is hingedly attached to a vertical support member 14 of the body 12 with hinge members 143 to allow access to the interior cavity 24 of the body. The hinge members 143 stabilize and prevent movement of the light supporting device 150 when the light supporting device 150 is adjacent the egg trays 28 or egg baskets 29 in a lighting position, yet allows the light supporting device 150 to be easily moved to a second non-lighting position that is not adjacent the eggs 30. To provide additional stability a magnetic device can be used to secure the light support device 150 and engage the body to hold the light supporting device 150 in place. The magnetic bond between the magnetic device and body is such that it holds light supporting device 150 in place yet is easily overcome by as a result of a worker pulling on the light supporting device.

Alternatively, as shown in FIGS. 2C and 3C, rail elements 144 are secured to the body 12 such that the light support device 150 is slidably moved from aligned with the body 12 to the side to allow access to the interior cavity 24 or setter or hatcher 10. Track members 144 are secured to the horizontal support members 20 and corresponding rolling elements 146 are secured to the light supporting device 150 and placed within the track members 144. Stop elements 148 are disposed within the track members 144 to prevent the rolling elements 146 from sliding out of the track members 144 when the light support device is moved from a first lighting position adjacent the holding members 27 to a second non-lighting position that is not adjacent the holding members 27.

In all example embodiments the light support device 150 is able to be moved from a first position adjacent the eggs 30 to a second position that is not adjacent the eggs 30 to allow access to the interior cavity 24 of the body so that trays 28 and/or baskets 29 can easily be removed and inserted to facilitate replacement or loading and retrieval or unloading of eggs 30 into the device 10. An electric motor or device can similarly be attached to the light supporting member to automatically move the light supporting device 150 without manual force without falling outside the scope of this disclosure. In addition, contemplated is the use of multiple light supporting devices 150 including but not limited to on more than one side of the incubating device 10 to allow maximum light penetration within the interior 24 of the body 12.

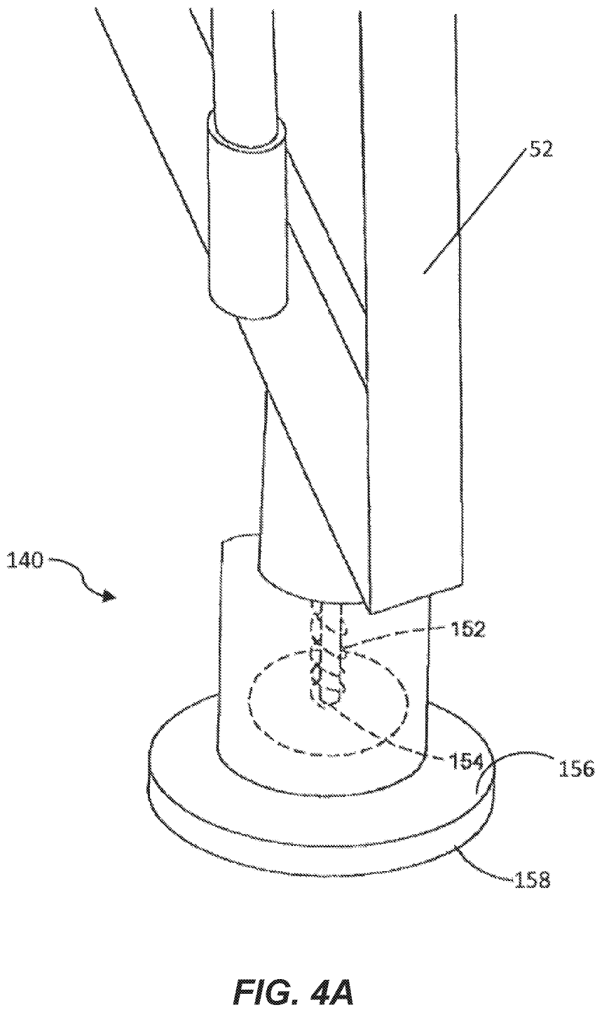

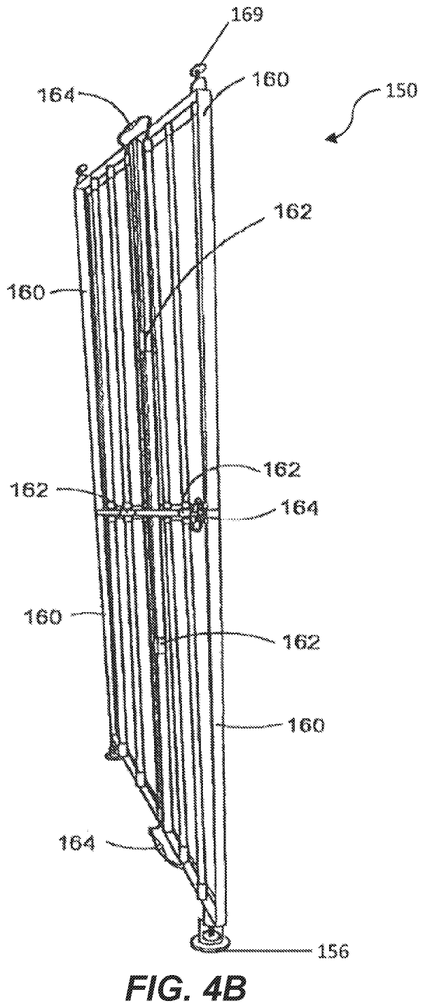

In an alternative example embodiment as shown in FIGS. 4A and 4B the attachment system 140 does not secure the light supporting device 150 to the body 12 and instead is secured within the incubation chamber 1. In one embodiment the light supporting device has foot members 156 that engage the floor of the incubation chamber 1. In one example the foot members 156 are secured to the floor through a fastener such as a bolt or the like and receives a vertical support member 52 of the light supporting device 150 to hold the lighting device 150 in a predetermined position to maximize the amount of light going into the interior cavity 24 of the body.

In one embodiment the foot members 156 are adjustable in height, either through a spring element 152 that is positioned between the vertical support member 52 and the floor to urge the vertical support member against the ceiling of the incubation chamber 1 to hold the light supporting device 150 in place in spaced relation to the body 12. Alternatively, the foot member 156 comprises a screw element 154 that increases in height as rotated to again compress and hold in place the light supporting device 150 between the ceiling and floor of the incubation chamber 1. Friction at the ceiling is provided by top feet 169.

In an example, shoe members 158 are secured to the floor of the incubation chamber at pre-determined locations and are of size and shape to receive and secure the foot member 156 of the light supporting device 150 therein. In this manner the light supporting device 150 is quickly inserted into the shoe member 158 by sliding the foot member 156 therein to correctly position the light supporting device 150. The height of the foot members 156 is then adjusted to hold the light supporting device 150 in place. When removal is needed the foot member 156 is lowered in height and the light supporting device 150 is easily and quickly removed so a worker can quickly gain access to the fan element or other elements behind the light supporting device 150 to ensure the light supporting device 150 while spaced apart from the body 12 remains in close proximity to the body 12 to maximize light coverage within the interior cavity 24 of the body 12 and on the eggs 30 therein.

The predetermined location of the shoe members 158 in one embodiment is between the rail element 9 and the fan element 5. In this manner the rail element 9 protects the light supporting device 150 from contact with an incubation device 10 as it is rolled or inserted into the incubation chamber 1 preventing potential damage to the lighting devices 60. In addition, this places the lighting devices 60 in front of the fan element 5 and in an embodiment wherein the lighting elements 70 are directional and reflective material is utilized, all light emitted by the lighting devices 60 is directed away from the fan element 5. Thus, the reflection of light off of the fan element 5 causing periodic or flickering light that has been shown to have negative effects on incubated eggs is reduced, eliminated and avoided preventing negative biological responses within the eggs 30.

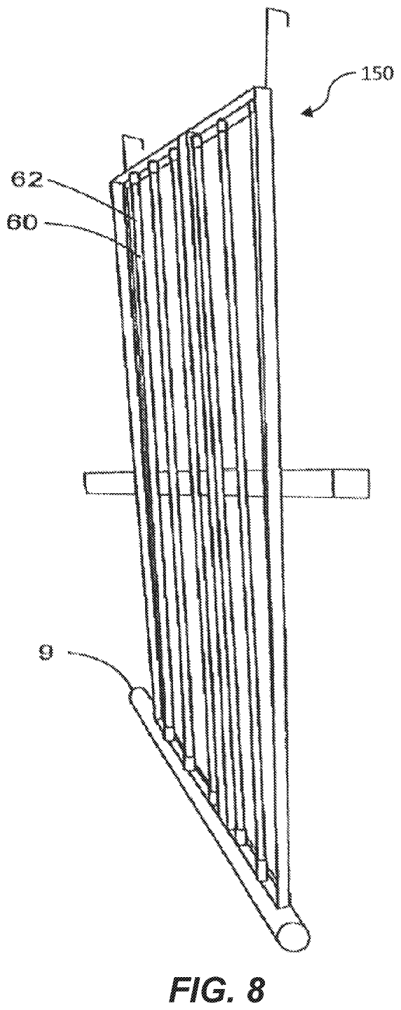

In another embodiment as shown in FIG. 8 the light supporting device 150 has an attachment system 140 that secures the light supporting device 150 to an auxiliary device within the incubation chamber 1 such as the temperature control member 4, the fan element 5 or a rail element 9. In these embodiments, the attachment systems can include but are not limited to magnetic attachment, spring loaded attachment members, fasteners, clips, or the like. In each embodiment the light supporting device 150 is removable or secured in such a way that it can be inserted and removed quickly and easily. In an embodiment where the light supporting device 150 is secured to the temperature control member 4, heat from the light supporting device 150 is directed to the temperature control member 4 through engagement of the lighting device 60, substrate 66 or heat sink to the temperature control member 4 or alternatively through use of a heat conveying conduit. The temperature control member 4 is then controlled by the control unit 6 to ensure the proper temperature within the chamber 1. By contacting the temperature control member 4 less variance in heat through the chamber is accomplished minimizing the effect of the heat generated by the lighting devices 60. In addition, by securing the light supporting device to and/or in front of the fan element 5 and using directional light elements and reflective material, periodic/flickering reflected light is reduced, eliminated and avoided preventing negative biological responses within the eggs 30.

FIG. 4B shows yet another example embodiment of the lighting device 150. In this example the lighting device is comprised of multiple interlocking sections 160. Each section 160 has its own set of lighting devices 60 and is of size and shape to encompass a predetermined area within the interior cavity 24 of the body 12. Each section 160 has an interlocking mechanism 162 to detachably secure to the other sections at predetermined points of connection. When each section 160 is connected to another section 162 a light supporting device 150 is formed that is of size and shape to irradiate the eggs in the interior cavity 24 from a single side of the body 12. Electrical connectors 164 connect wiring 56 from the individual lighting devices 60 of each section 160 to the lighting devices 60 of another section in a waterproof manner. In this way the lighting devices 60 of all of the sections 160 are electrically connected and controlled by a single control unit 6 after they are interconnected. By having individual sections 160, the sections are easier to handle allowing for faster and easier installation and removal. In addition, by making the connectors 164 waterproof the light support device 150 can be cleaned during a cleaning of the incubation chamber 1.

In yet another example embodiment, the light supporting device 150 is built into the incubation chamber 1 itself similar to the fan element 5 and temperature control member 4 without falling outside the scope of this invention. This is as one-piece construction with the incubation chamber 1 or otherwise. In particular during construction of the incubation chamber 1 the light supporting device 150 is made a permanent fixture with the incubation chamber 1 and positioned to align the lighting devices 60 adjacent to the incubation devices 10 such that when all of the incubation devices 10 are within the incubation chamber 1 the light supporting devices 150 are adjacent the incubation devices 10 in a lighting position.

In one example embodiment, when the eggs 30 are ready for hatching the incubation devices 10 are removed from the incubation chamber 1 and the light supporting device 150 is removed from being adjacent from the incubation device 10. At this point the light supporting device 150 is considered in a non-lighting position. This is accomplished by either pulling the light supporting device 150 off the body 12, sliding it away from the body 12, hingedly pivoting the light supporting device 150 or otherwise to provide access to the egg trays 28 in the interior cavity 24 of the incubating device 10. The trays 28 are then removed and taken to a hatching device or another location and new egg trays 28 containing eggs 30 are inserted into the incubating device 10. The light supporting device 150 is then placed back adjacent the interior cavity 24 to its lighting position. If cleaning is desired, the light supporting device 150 can be removed for cleaning purposes or left on the incubating device the lighting devices 60 and electrical connections are waterproofed to withstand a power washing device.

In the drawings, the lighting devices 60 are generally shown in a vertical arrangement. The lighting devices 60 can also be placed in a horizontal direction. For example, the lighting elements 60 used with a hatching device 10 from FIG. 2B, can have horizontal lights that are located near the top of each hatching basket 29 so that the eggs 30 all receive light and are not shaded. Also, while all the lights disclosed herein are on the outside of the setter and hatcher carts, the lights can also be provided between the egg holders 28 or the egg hatching trays 29. For example, see U.S. provisional application No. 62/503,504 and. U.S. Ser. No. 14/992,935, as published in U.S. Pub. No. 2016/0120155, each of which are incorporated herein by reference.

In a trial conducted by applicant, applicant provided lighting devices 60 with a lighting treatment having predetermined wavelengths substantially concentrated between 550 nm 570 nm at an intensity of 300-600 mW/m² for 24-hours a day during the entire incubation period. Under this intensity and energy provided the embryos hatched a half to one-day earlier than dark-exposed embryos. Thus, the time to hatch was accelerated compared to the control. The hatching period, or the time of the first egg to hatch until the last egg hatched, from the experimental group compared to the control group was also less or reduced. At the same time no significant effects on percent hatchability have been detected.

Additionally, during experiments, over the course of embryonic development, a significant effect of 20% increased weight by embryonic day 5, with increased body weight persisting through hatching was observed. The hatched chicks did not appear to be significantly different in weight as compared to the dark-exposed control group even though they were hatching a half day to full day prior to the control. Several developmental milestones were earlier in the green light-exposed embryos, including earlier appearance of feathers, coloration of feathers, and absorption of the yolk sac. Thus, at any given time point in development, the Hamburger and Hamilton (HH) stage (Hamburger and Hamilton, 1992) would be advanced in the light-treated embryos relative to the control embryos.

Further, by controlling the narrow band of light and the photoperiod, overall hatching time is reduced. Specifically, typically from the time the first incubated egg hatches to the time the last egg in that same group hatches can be up to 48-hours of time. This means eggs must be removed well in advance to hatching, decreasing the full incubation time and making the process longer and unpredictable. By controlling the wavelength and photoperiod the overall hatching period is reduced from up to 48-hours to less than 8-hours. By reducing the hatching period efficiencies are improved, eggs 30 are in an incubation period for a more appropriate amount of time and overall egg production is increase.

In one example, a method is provided wherein the lighting devices 60 are operating for predetermined time intervals for a pre-determined period at a predetermined wavelength. In an example embodiment, the pre-determined time interval is 16-hours of light with 8-hours of dark. In another example embodiment, the pre-determined period is between days 0 and 3.5 of incubation and the predetermined wavelength is between either 495 nm-570 nm or 620 nm-660 nm. These ranges are for example only and other predetermined wavelengths, including wavelengths not visible to humans from 300 nm to 800 nm, and predetermined periods and predetermined time intervals including times as short as milliseconds can vary without falling outside the scope of this invention.

In another example, a method is provided wherein a light treatment providing a narrow band substantially concentrated in green wavelengths can be provided in days 0-7 of incubation to increase muscle mass of the embryo and resulting avian after hatching.

The effecting of myogenesis in broilers by green light can have two important values: first, increasing breast meat in adult birds resulting in higher value of meat per bird raised. Second, altering myogenesis to result in a decrease in myopathies such as white striping and wooden breast syndrome. These myopathies result in meat of lower perceived quality, and thus carrying a lower value. The use of green light therefore increases the value of the meat produced.

In yet another example, a method is provided wherein by utilizing a narrow band substantially concentrated in green wavelengths development of chicken embryos is accelerated, reducing the time of incubation by up to 4%, or 5% or more, allowing more incubation cycles per year per hatchery. Reducing the incubation time also proportionally reduces the exposure of embryos to pathogens, reduces the relative amount of energy used in the incubators, and reduces the chance of mechanical malfunction from compromising a set of eggs. A narrower hatch window also allows chicks to be removed from the hatching incubator in a timelier fashion before the earliest-hatched chicks become dehydrated or starved.

In another embodiment, applicant has determined that by utilizing a narrow band of light, substantially concentrated in green wavelengths between 500 nm and 600 nm, myopathy in grown birds can be minimized. Even as compared to prior art methods that appeared to show increased muscle growth, myopathy is still a problem. This myopathy may have been caused by the muscle fibers in the breast that had too much muscle growth and the muscle growth was too fast. As a result, some muscle fibers died, resulting in myopathy. Myogenesis occurs mainly during embryogenesis and early posthatch. Skeletal muscle originates from four types of myogenic cell populations: myotomal cells, embryonic myoblasts, fetal myoblasts and satellite cells (adults). Myotomal cells and embryonic myoblasts divide and fuse to form myotubes. Fetal myoblasts give rise to secondary muscle fibers. Satellite cells are used for muscle regeneration and self-renewal. By using the methods disclosed herein, green light of approximately 560 nm, or in a range of 535 nm to 570 nm, the avian embryos experienced an increased production of myoblast and satellite cells. As the embryo developed, this increased number of myoblast cells resulted in a larger number of muscle fibers, not just fibers of a larger size. The increase in the number of satellite cells allows the avian muscle fibers to more easily be repaired when damaged due to exercise. Due to the larger number of muscle fibers and increased healing, the avian animals had increased breast size and weight, but a reduced incidence of myopathy.

In an example embodiment, an improvement over the prior art is shown by using green light in a continuous, circadian, manner. By administering green light for between 8 and 16 hours per day, preferably 8, 10, 12, 14, or 16 hours, with the rest of the time the eggs experiencing darkness, the embryos are entrained to a natural circadian rhythm. Intermittent or 24-hour use of green light will result in ultradian cycle. It is known that the melatonin cycle is enhanced by a regular circadian rhythm. The melatonin cycle interacts with many body functions including muscle growth. By having a regular circadian rhythm, the avian species will experience optimal muscle fiber size and number. When establishing a circadian rhythm in an avian species embryo, it is best to match the day/night cycle that the newborn chick will experience. So, while circadian lighting can be on between 8 and 16 hours per day with the remainder of the time being dark, the particular time of day when the lights are turned on and off should be matched with what the chicks will experience after hatch. In some embodiments, the circadian lights can be gradually turned on and gradually turned off so that over a period of, for example, about 30-minutes, the embryos will experience gradual light on and gradual light off (in essence, a sunrise and a sunset).

In an example embodiment, an improvement over the prior art is shown by administering a proper amount of light to eggs. The green light transmission through the egg shell depends upon a variety of factors including: the avian species, the particular species of avian and the color of the egg. For example, for chicken eggs, it is known that white egg shells transmit about six times more green light than brown egg shells do. In one example, the avian egg surface needs to receive between 0.2 Watts per square meter (W/m²) and 10 W/m² to achieve optimal myopathy reduction. For white eggs, a light or lighting assembly delivering a range from 0.2 to 2.0 W/m² can provide optimal myopathy reduction, and for brown or other colored eggs a range of 1.0 to 10 W/m² can provide optimal myopathy reduction.

In another example embodiment, an improvement over the prior art is shown by administering the green light at the proper time. For example, lighting should be applied during one or more of the three critical stages of embryogenesis: Early embryogenesis (E1.5-E4 for chickens) when somite formation occurs and myogenic markers Myf5, MyoD, Myogenin, and Myostatin are first expressed; middle embryogenesis (E12-E17 for chickens) when many myogenic genes show peak expression patterns (IGF-1, MyoD, Myogenin and Myostatin), and perinatally (E19-E21 for chickens) when post-embryonic fiber number becomes determined and another peak of myogenic genes occurs (Myf5, MyoD, and tropomyosin). In one example, when incubating chicken eggs, the green light is administered to the eggs from day 1 to 5 and again from day 12 to 21 (hatch). In another example, the green light can be administered during the entire incubation process, to take into account variations of this timing.

In another example embodiment, an improvement over the prior art is shown by controlling the temperature of the incubation chamber. It is known that increased incubation temperature will result is quicker hatching and smaller chick size. However, yolk sac absorption may not be complete and organ weight is diminished. The standard temperature for chicken incubation is 99° to 100° F. (37.3°-37.8° C.). The applicants have found that by controlling the temperature to a range between 98° and 101° F., reduced myopathy is shown. This +/−1.0° F. (+/−0.6° C.) range is similar for all avian species. For avian species, the higher the incubation temperature, the shorter the incubation time. A temperature too high leads to early hatching and smaller chicks; whereas a temperature too low results in hatching delay from 2 to 12 hours depending on temperature, and larger chicks. In both cases, extremes also lead to an increase in embryonic mortality.

In some example embodiments, light substantially in the red wavelength was used, along with the green light, to improve hatchability. The red light has a wavelength of approximately 620 nm to 780 nm. Red light is known to entrain circadian rhythm and increase the metabolism of the embryos. Hatchability can be defined as the ratio of the number of eggs hatched divided by the number of eggs put into the incubator. By using this red light, the hatchability ratio is increased. In some embodiments, this red light is only used during the last 9 to 12 days of incubation. For average chickens, this would be days 9 to 21 or days 12 to 21. In some embodiments, the red light was only used 8 to 1.2 hours a day to help establish the circadian rhythm of the avian species. In some embodiments, red light is only used during the exothermic portion of the avian species incubation period.

In some embodiments, blue light was used along with green light to control the sex of the avian species. See for example, U.S. patent publication 2016/0165849, assigned to Once Innovations, the contents of which are incorporated hereby by reference. Applicants have shown that blue light in either the range of 410 nm to 450 nm or from 450 nm to 495 nm has an effect on the sex of the hatched embryos.

The first phase of incubation (until 8 days of incubation, approximately, for chickens), when the embryo requires heat in order to develop, is called the endothermic phase. During this first phase, insufficient heating can result in early embryonic deaths and impair the incubation final outcome. The second phase (from approximately 8 days of incubation onwards, for chickens) when the embryo produces heat which is needed to be dissipated; hence, this is the exothermic phase.

While many examples herein are for chicken species, this invention is equally applicable to other avian species. For turkeys, the incubation period totals 28 days and the preferred incubation temperature is 99.5-100° F. (37.5-38.1° C). For ducks, incubation time varies between 28 and 35 days, depending on species, and the preferred incubation temperature is 99.5° F. (375° C.) during the setting period and then 99° F. (372° C.) during the hatching period. For quail, incubation time is 17 to 18 days, depending on species, and the preferred incubation temperature is 99.5° F. (37.5° C.) during the setting period and then 99° F. (37.2° C.) during the hatching period. For all avian species, the setting time is from 0 to three days before hatching and the hatching time is the last three days of the incubation period.

Thus, presented are multiple embodiments of light supporting devices 150 that are placed in an incubation chamber to emit light of pre-determined wavelengths and for pre-determined periods to promote biological responses with the incubated eggs such as increased number of breast muscles, decreased myopathies, increased hatchability and sex selection. This is accomplished with minimal installation effort and in manners that minimize the effect on other aspects of a commercial incubation chamber and facility such as egg retrieval and insertion. In addition, heat is controlled to ensure deleterious effects on the eggs are not realized and the system accommodates washing and sanitation efforts by workers within a facility. Therefore, at the very least all of the problems have been overcome.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

1. A method for decreasing myopathy in breast muscles of an avian species, the method comprising:
administering a green light having a wavelength between 500 and 600 nanometers (nm) to avian eggs during an early embryogenesis, a middle embryogenesis, and a perinatal stage of the avian eggs during incubation;
wherein myoblast and satellite cell production is increased in the avian eggs in response to the administration of the green light.

2. The method of claim 1, further comprising administering the green light to the avian eggs in a manner which entrains the embryo's circadian rhythm.

3. The method claim 1, further comprising:
establishing a preferred temperature range for the incubation of the avian eggs; and
controlling a temperature inside an incubation chamber housing the avian eggs to continuously be within one-degree Fahrenheit of the preferred temperature range.

4. The method of claim 1, further comprising:
administering the green light to the avian eggs in a manner which entrains the embryo's circadian rhythm;
establishing a preferred temperature range for the incubation of the avian eggs; and
controlling a temperature inside an incubation chamber housing the avian eggs to continuously be within one-degree Fahrenheit of the preferred temperature range.

5. (canceled)

6. The method of claim 1, wherein administering the green light includes delivering between 0.2 Watts per square meter (W/m²) and 10 W/m² to a surface of the avian eggs.

7. The method claim 1, further comprising administering a red light having a wavelength between 620 and 780 nm to the avian eggs.

8. The method of claim 7, wherein the red light is administered only after the avian eggs are in an exothermic phase of an incubation cycle.

9. The method of claim 7, wherein the red light is administered in a manner which entrains an embryo's circadian rhythm in the avian eggs.

10. The method of claim 1, further comprising exposing the avian eggs to a substantially blue wavelength of light during a period of time during a first seven days of incubation of the avian eggs.

11. The method of claim 10 wherein the period of time is 24-hours per day.

12. The method of claim 1 further comprising controlling on and off times of the green light and an intensity of the green light with a control system electrically connected to the light.

13. The method of claim 1 wherein the green light is generated by a plurality of light emitting diodes.

14. The method of claim 7 wherein the red light is generated by a plurality of light emitting diodes.

15. The method of claim 1 wherein the avian species is one of chicken, turkey, or duck.

16-17. (canceled)

18. The method of claim 1, wherein the increased number of myoblast and satellite cells results in an increased number of muscle fibers and improved muscle regeneration in the breast muscles of the avian species.

19. A method for reducing the average hatch time for avian eggs, the method comprising:
exposing avian eggs, during incubation, to a green light having a wavelength between 500 and 600 nanometers (nm);
wherein the average hatch time of the avian eggs is reduced by at least 4% and chicks hatched from the avian eggs do not exhibit sub-optimal development.

20. (canceled)

21. The method of claim 19, further comprising:
establishing a preferred temperature range for the incubation of the avian eggs; and
controlling a temperature inside an incubation chamber housing the avian eggs to continuously be in within one-degree Fahrenheit of the preferred temperature range.

22. The method of claim 19, wherein the green light is provided in a circadian manner for the entire incubation period.

23. The method of claim 19, wherein the avian eggs are chicken eggs, turkey eggs, or duck eggs.

24-25. (canceled)

26. The method of claim 19, wherein the green light delivers between 0.2 Watts per square meter (W/m²) and 10 W/m² to a surface of the avian eggs.
